(19) United States
(12) Patent Application Publication
(10) Pub. No.: US 2022/0227284 A1
(43) Pub. Date: Jul. 21, 2022

(54) METHODS AND SYSTEMS FOR AUTOMATIC HEADLAMP AIM OPTIMIZATION

(71) Applicant: GM GLOBAL TECHNOLOGY OPERATIONS LLC, Detroit, MI (US)

(72) Inventor: Patrick Minjeur, Sterling Heights, MI (US)

(73) Assignee: GM GLOBAL TECHNOLOGY OPERATIONS LLC, Detroit, MI (US)

(21) Appl. No.: 17/152,088

(22) Filed: Jan. 19, 2021

(51) Int. Cl. B60Q 1/08

(52) U.S. Cl. CPC B60Q 1/08; B60Q 2200/38

(57) ABSTRACT

A method for controlling forward lighting of a vehicle includes projecting, from a headlamp of the vehicle, an optimization pattern ahead of the vehicle and capturing, by a vehicle sensor, image data of the optimization pattern. The method also includes receiving, by a vehicle controller, the image data of the optimization pattern, measuring, from the image data, a headlamp aim offset defined as a difference in a position of the optimization pattern from a nominal position, and controlling an aim of the headlamp of the vehicle based on the headlamp aim offset.

### INTRODUCTION

The present disclosure relates generally to methods and systems for automatic headlamp aim optimization.

Vehicles commonly use forward lighting, such as headlamps, when initiated by an operator of the vehicle, for example during evening hours. However, due to manufacturing variations, the headlamp aim may vary from the desired orientation, necessitating headlamp adjustment mechanisms to physically adjust the vertical and/or horizontal aim of the headlamp.

### SUMMARY

Embodiments according to the present disclosure provide a number of advantages. For example, embodiments according to the present disclosure enable automatic adjustment of a headlamp beam pattern to account for manufacturing variation, thus eliminating the need for headlamp adjustment mechanisms that increase manufacturing complexity and cost.

In one aspect of the present disclosure, a method for controlling forward lighting of a vehicle includes projecting, from a headlamp of the vehicle, an optimization pattern ahead of the vehicle and capturing, by a vehicle sensor, image data of the optimization pattern. The method further includes receiving, by a vehicle controller, the image data of the optimization pattern, measuring, by the vehicle controller, from the image data, a headlamp aim offset defined as a difference in a position of the optimization pattern from a nominal position, and calibrating, by the vehicle controller, an aim of the headlamp of the vehicle based on the headlamp aim offset.

In some aspects, the method further includes creating and storing, by the vehicle controller, a headlamp aim calibration based on the headlamp aim offset.

In some aspects, the method further includes initiating, by the vehicle controller, a headlamp aim optimization mode.

In some aspects, initiation of the headlamp aim optimization mode is triggered automatically when the vehicle encounters a triggering event.

In some aspects, the optimization pattern includes a geometric shape having distinct lines such that the aim of the headlamp is compared to a nominal lateral position and a nominal vertical position.

In some aspects, a first beam reference line and a second beam reference line intersect at an intersection point of the optimization pattern.

In some aspects, a longitudinal centerline reference line and a lateral reference line establish a desired aim direction for the headlamp.

In some aspects, measuring the headlamp aim offset includes measuring a longitudinal difference between the lateral reference line and the second beam reference line and a lateral difference between the longitudinal reference line and the first beam reference line.

In some aspects, the vehicle sensor is a camera.

In another aspect of the present disclosure, a system for controlling forward lighting of a vehicle includes a headlamp configured to project lighting forward of the vehicle, an image sensor configured to capture image data of a position ahead of the vehicle, and a vehicle controller including a control module in electronic communication with the headlamp. The vehicle controller is also in electronic communication with the image sensor and is configured to instruct the headlamp to project an optimization pattern ahead of the vehicle. The controller is also configured to receive the image data of the optimization pattern from the image sensor, measure, from the image data, a headlamp aim offset defined as a difference in a position of the optimization pattern from a nominal position, and control an aim of the headlamp of the vehicle based on the headlamp aim offset.

In some aspects, the vehicle controller is further configured to create and store a headlamp aim calibration based on the headlamp aim offset.

In some aspects, the vehicle controller is further configured to initiate a headlamp aim optimization mode.

In some aspects, initiation of the headlamp aim optimization mode is triggered automatically when the vehicle encounters a triggering event.

In some aspects, the optimization pattern includes a geometric shape having distinct lines such that the aim of the headlamp is compared to a nominal lateral position and a nominal vertical position.

In some aspects, the control module is an adaptive forward lighting module of the vehicle.

In another aspect of the present disclosure, an automotive vehicle includes a vehicle body including a headlamp coupled to the vehicle body, an image sensor coupled to the vehicle body and configured to capture image data of a position ahead of the vehicle, and a vehicle controller in electronic communication with the headlamp and the image sensor. The vehicle controller is configured to instruct the headlamp to project an optimization pattern ahead of the vehicle, receive, from the image sensor, the image data of the optimization pattern projected ahead of the vehicle, measure, from the image data, a headlamp aim offset defined as a difference in a position of the optimization pattern from a nominal position, and control an aim of the headlamp of the vehicle based on the headlamp aim offset.

In some aspects, the vehicle controller includes an adaptive forward lighting module that is configured to create and store a headlamp aim calibration based on the headlamp aim offset.

In some aspects, the optimization pattern includes a geometric shape having distinct lines such that the aim of the headlamp is compared to a nominal lateral position and a nominal vertical position.

In some aspects, a first beam reference line and a second beam reference line intersect at an intersection point of the optimization pattern and a longitudinal centerline reference line and a lateral reference line establish a desired aim direction for the headlamp.

In some aspects, measuring the headlamp aim offset includes measuring a longitudinal difference between the lateral reference line and the second beam reference line and a lateral difference between the longitudinal reference line and the first beam reference line.

### BRIEF DESCRIPTION OF THE DRAWINGS

The present disclosure will be described in conjunction with the following figures, wherein like numerals denote like elements.

FIG. 1 is a functional block diagram of a control system for controlling an automatic headlamp aim optimization for a vehicle, according to an embodiment.

FIG. 2 is a schematic illustration of an overhead view of a vehicle having at least one headlamp and an alignment pattern used to optimize the aim of the headlamp, according to an embodiment.

FIG. 3 is a flowchart of a method for automatic headlamp aim optimization, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description fix the purpose of reference only, and thus are not intended to be limiting. For example, terms such as “above” and “below” refer to directions in the drawings to which reference is made. Terms such as “front,” “back,” “Left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

The systems and methods disclosed herein automatically adjust a headlamp beam pattern to account for manufacturing variation. This eliminates the need for mechanical headlamp adjusters for vertical and horizontal aim. Additionally, the automatic headlamp aim adjustment system utilizes one or more vehicle cameras and sensors to detect a pattern projected in front of the vehicle. A vehicle controller compares the projected pattern to a centerline or pre-prescribed distance and then adjusts the lateral and/or vertical calibrations in a headlamp control module to adjust for any discrepancy.

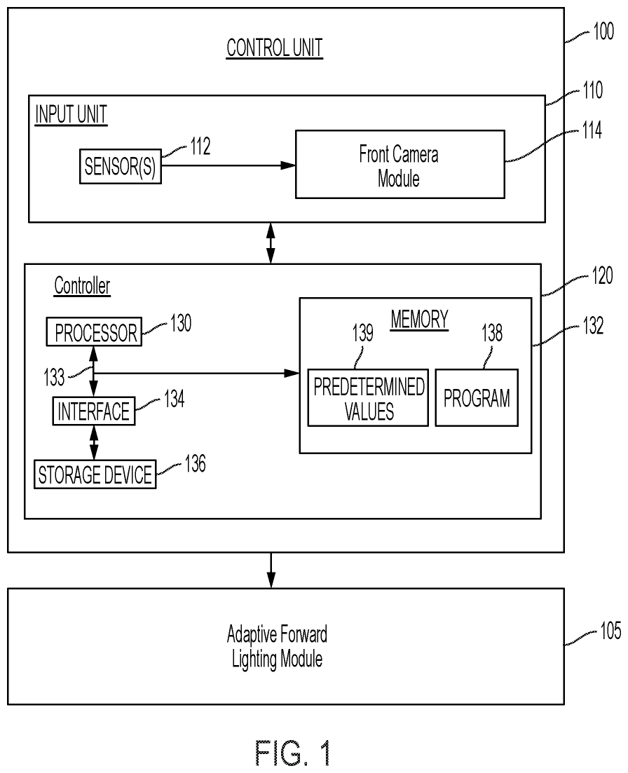

FIG. 1 is a functional block diagram of a control system 100 for controlling an automatic headlamp aim optimization for a vehicle, in accordance with an exemplary embodiment of the present disclosure. In certain preferred embodiments, the vehicle includes an automobile such as a sedan, a truck, a van, a sport utility vehicle, or another type of automobile. However, in various embodiments, the control system 100 can be used in connection with any number of types of vehicles and/or systems thereof.

As depicted in FIG. 1, the control system 100 is configured to be coupled to an adaptive forward lighting module 105 of the vehicle. In the depicted embodiment, the control system 100 includes an input unit 110 and a controller 120. However, this may vary in other embodiments.

The input unit 110 is configured to obtain and provide input values for use in determining a headlamp aim adjustment for the vehicle. In certain exemplary embodiments, the input unit 110 includes one or more sensors 112 of the vehicle. Certain sensors 112, for example, are disposed proximate a front end of the vehicle to project an optimization pattern forward of the vehicle. In various embodiments, certain sensors 112 are disposed proximate a front end of the vehicle to capture an image of the optimization pattern and the alignment of the headlamp beam with the optimization pattern. Various other types of sensors 112 may also be utilized in various embodiments of the present disclosure.

In various embodiments, the sensors 112 of the input unit 110 are in electronic communication with a front camera module 114. The front camera module 114 is configured to receive and analyze data from one or more of the sensors 112, such as a light sensor and/or camera, project an optimization pattern, capture data regarding the headlamp aim as compared to the optimization pattern, and transfer this data to the controller 120 for use in calculation of any discrepancies between the headlamp aim and the optimization pattern, for example and without limitation.

In an exemplary embodiment, the input unit 110 includes a light sensor and/or camera. In yet other embodiments, the input unit 110 may include any one or more of a number of other different types of units, devices, and/or systems.

The controller 120 receives the input values from the input unit 110, determines whether a discrepancy exists between the headlamp aim and the optimization pattern, measures the amount of the discrepancy using the input values, determines an adjustment calibration to be made to the headlamp aim, and controls the forward lighting accordingly for the vehicle via the adaptive forward lighting module 105. In certain embodiments, the controller 120 adjusts the headlamp aim for the vehicle by providing appropriate instructions to the forward lighting unit 105 of the vehicle to optimize the headlamp aim based on the adjustment calibration determined from the comparison of the headlamp aim to the optimization pattern. In one embodiment, the controller 120 is part of a body control module of the vehicle. However, this may vary in other embodiments.

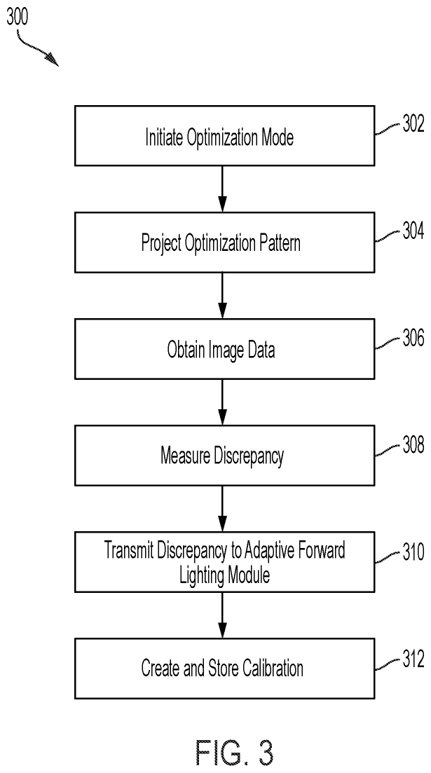

In the depicted embodiment, the controller 120 includes a processor 130, a memory 132, a bus 133, an interface 134, and a storage device 136. The processor 130 performs the computation and control functions of the controller 120 or portions thereof. Specifically, in some embodiments, the processor 130 is configured to at least facilitate controlling the headlamp aim optimization of the vehicle by implementing steps of one or more processes such as the process 300 of FIG. 3.

The processor 130 may include any type of processor or multiple processors, single integrated circuits such as a microprocessor, or any suitable number of integrated circuit devices and/or circuit boards working in cooperation to accomplish the functions of a processing unit. During operation, the processor 130 executes one or more programs 138 preferably stored within the memory 132 and, as such, controls the general operation of the controller 120.

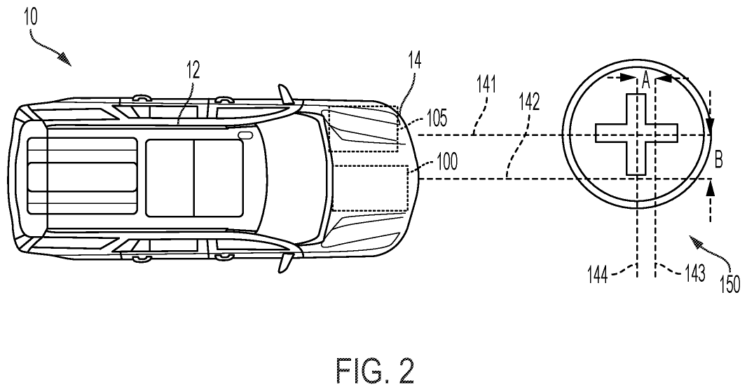

As referenced above, the memory 132 stores a program or programs 138 that execute one or more embodiments of processes such as the process 200 described below in connection with FIG. 2 and/or various steps thereof and/or other processes, such as those described elsewhere herein. In addition, in one embodiment, the memory 132 stores one or more predetermined values 139 for subsequent comparison with the input values obtained from the input unit 110 for determining by the processor 130 of an optimal headlamp aim for the vehicle.

The memory 132 can be any type of suitable memory. This would include various types of dynamic random access memory (DRAM) such as SDRAM, various types of static RAM (SRAM), and various types of non-volatile memory (PROM, EPROM, and flash). It should be understood that the memory 132 may be a single type of memory component, or it may be composed of many different types of memory components. In addition, the memory 132 and the processor 130 may be distributed across several different computers. For example, a portion of the memory 132 may reside on a computer within a particular apparatus or process, and another portion may reside on a remote computer.

The bus 133 serves to transmit programs, data, status, and other information or signals between the various components of the controller 120. The bus 133 can be any suitable physical or logical means of connecting computer systems and components. This includes, but is not limited to, direct hard-wired connections, fiber optics, and infrared and wireless bus technologies.

The interface 134 allows communication to the controller 120, for example from a vehicle user, a system operator, and/or another computer system, and can be implemented using any suitable method and apparatus. In an embodiment, the interface 134 provides information to the processor 130 for use in controlling and adjusting the aim of the forward lighting of the vehicle.

The storage device 136 can be any suitable type of storage apparatus, including direct access storage devices such as hard disk drives, flash systems, floppy disk drives and optical disk drives. In one exemplary embodiment, the storage device 136 is a program product from which memory 132 can receive a program 138 that executes one or more embodiments of the process 200 of FIG. 2 and/or steps thereof as described in greater detail further below. In one embodiment, such a program product can be implemented as part of, inserted into, or otherwise coupled to the control system 100.

It will be appreciated that while this exemplary embodiment is described in the context of a fully functioning computer system for the controller 120, those skilled in the art will recognize that the mechanisms of the present disclosure are capable of being distributed as a program product in a variety of forms, and that the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will similarly be appreciated that the controller 120 depicted in FIG. 1 may include any one or more of a number of other types of control modules and/or computer systems in various other embodiments of the present disclosure. In addition, in certain embodiments, the input unit 110 may be part of the controller 120 and/or may be part of one or more other different computer systems and/or other systems and/or devices.

FIG. 2 is a schematic illustration of a vehicle 10 having a body 12. The vehicle body 12 includes a headlamp 14. The vehicle 10 includes the control system 100 discussed in FIG. 1. An optimization pattern 150 is projected or displayed in front of the vehicle 10. The optimization pattern 150 is projected by the headlamp 14. In various embodiments, the optimization pattern 150 includes a geometric shape such as a cross, X, target, etc. having distinct lines such that the headlamp aim is measured or compared to nominal values, including a nominal lateral position and a nominal vertical position.

As shown in FIG. 2, the headlamp 14 has a first beam reference line 141 and a second beam reference line 144 that interfaces with the optimization pattern 150 projected from the headlamp 14 of the vehicle 10. As shown, the first beam reference line 141 is a longitudinal line and the second beam reference line 144 is a lateral line that intersect at an intersection point of the optimization pattern 150. A longitudinal centerline reference line 142 and a lateral reference line 143 establish a desired aim direction for the headlamp 14. A longitudinal difference A is measured between the lateral reference line 143 and the second beam reference line 144. Similarly, a lateral difference B is measured between the longitudinal reference line 142 and the first beam reference line 141. The longitudinal difference A and the lateral difference B establish a headlamp aim offset. The headlamp aim offset is used by the control system 100 of FIG. 2 to calibrate the aim of the headlamp 14.

In various embodiments, a camera, one of the sensors 112, is used to detect the position of the optimization pattern 150 projected in front of the vehicle 10. The image data captured by the camera is used to measure the offset of the headlamp aim as illustrated by the optimization pattern 150 in comparison to nominal values. The measured offset is used by the controller 120 to adjust the headlamp aim for the vehicle 10 by providing appropriate instructions to the adaptive forward lighting module 105 of the vehicle 10 to optimize the headlamp aim based on the measured discrepancy. The adaptive forward light module 105 creates and stores the measured discrepancy, or offset, as a headlamp calibration, thus shifting the shadow areas created by the headlamp aim to adjust for manufacturing variability without a physical adjustment to the headlamp hardware.

FIG. 3 illustrates a method 300 to automatically optimize a headlamp aim for a vehicle. The method 300 can be utilized in connection with the vehicle 10, control system 100, and the adaptive forward lighting module 105. The method 300 can be utilized in connection with the controller 120 as discussed herein, or by other systems associated with or separate from the vehicle, in accordance with exemplary embodiments. The order of operation of the method 300 is not limited to the sequential execution as illustrated in FIG. 3, but may be performed in one or more varying orders, or steps may be performed simultaneously, as applicable in accordance with the present disclosure.

Beginning at 302, an optimization mode is initiated. The initiation may happen automatically, such as when the vehicle 10 encounters a triggering event or is in a triggering location, for example, a headlamp calibration area at a manufacturing plant. In various embodiments, the optimization mode is initiated manually via an input to the control system 100.

Next, at 304, the optimization pattern is projected ahead of or in front of the vehicle 10. The optimization pattern is projected, in some embodiments, by the adaptive forward lighting module 105, upon receipt of instructions from the control system 100. Image data of the projected optimization pattern is obtained by a camera, such as one of the sensors 112, as shown at 306. In various embodiments, the camera is a sensor 112 associated with the front camera module 114 of the input unit 110.

The image data is transmitted to, processed, and analyzed by the controller 120 of the control system 100, as shown at 308. Analysis of the image data includes comparing the image data to predetermined nominal lateral and longitudinal, as well as vertical, positions. The analysis includes measuring or otherwise determining a difference, discrepancy, or offset between the position of the optimization pattern and the nominal positions, as shown in FIG. 2.

Next, at 310, the measured discrepancy is transmitted to the adaptive forward lighting module 105. At 312, from the measured discrepancy, the adaptive forward lighting module 105 determines a headlamp aim calibration. The headlamp aim calibration includes a “manufacturing variability” offset to adjust the headlamp aim through a software calibration rather than a physical adjustment of the headlamp hardware. The offset or discrepancy is stored as a calibration, thus enable a shift of shadow areas created by the headlamps to adjust for manufacturing variability.

While the above process is described in reference to a single headlamp, it is understood that the method 300 may be performed by each headlamp 14 of the vehicle 10 to determine a separate offset and calibration for each headlamp 14.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters. shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software, and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for controlling forward lighting of a vehicle, comprising:
projecting, from a headlamp of the vehicle, an optimization pattern ahead of the vehicle;
capturing, by a vehicle sensor, image data of the optimization pattern;
receiving, by a vehicle controller, the image data of the optimization pattern;
measuring, by the vehicle controller, from the image data, a headlamp aim offset defined as a difference in a position of the optimization pattern from a nominal position; and
calibrating, by the vehicle controller, an aim of the headlamp of the vehicle based on the headlamp aim offset.

2. The method of claim 1 further comprising creating and storing, by the vehicle controller, a headlamp aim calibration based on the headlamp aim offset.

3. The method of claim 1 further comprising initiating, by the vehicle controller, a headlamp aim optimization mode.

4. The method of claim 3, wherein initiation of the headlamp aim optimization mode is triggered automatically when the vehicle encounters a triggering event.

5. The method of claim 1, wherein the optimization pattern includes a geometric shape having distinct lines such that the aim of the headlamp is compared to a nominal lateral position and a nominal vertical position.

6. The method of claim 5, wherein a first beam reference line and a second beam reference line intersect at an intersection point of the optimization pattern.

7. The method of claim 6, wherein a longitudinal centerline reference line and a lateral reference line establish a desired aim direction for the headlamp.

8. The method of claim 7, wherein measuring the headlamp aim offset comprises measuring a longitudinal difference between the lateral reference line and the second beam reference line and a lateral difference between the longitudinal centerline reference line and the first beam reference line.

9. The method of claim 1, wherein the vehicle sensor is a camera.

10. A system for controlling forward lighting of a vehicle, comprising:
a headlamp configured to project lighting forward of the vehicle;
an image sensor configured to capture image data of a position ahead of the vehicle; and
a vehicle controller including a control module in electronic communication with the headlamp, the vehicle controller also in electronic communication with the image sensor, and the vehicle controller is configured to:
instruct the headlamp to project an optimization pattern ahead of the vehicle;
receive the image data of the optimization pattern from the image sensor;
measure, from the image data, a headlamp aim offset defined as a difference in a position of the optimization pattern from a nominal position; and
control an aim of the headlamp of the vehicle based on the headlamp aim offset.

11. The system of claim 10, wherein the vehicle controller is further configured to create and store a headlamp aim calibration based on the headlamp aim offset.

12. The system of claim 10, wherein the vehicle controller is further configured to initiate a headlamp aim optimization mode.

13. The system of claim 12, wherein initiation of the headlamp aim optimization mode is triggered automatically when the vehicle encounters a triggering event.

14. The system of claim 10, wherein the optimization pattern includes a geometric shape having distinct lines such that the aim of the headlamp is compared to a nominal lateral position and a nominal vertical position.

15. The system of claim 10, wherein the control module is an adaptive forward lighting module of the vehicle.

16. An automotive vehicle, comprising:
a vehicle body including a headlamp coupled to the vehicle body;
an image sensor coupled to the vehicle body and configured to capture image data of a position ahead of the vehicle; and
a vehicle controller in electronic communication with the headlamp and the image sensor, the vehicle controller configured to:
instruct the headlamp to project an optimization pattern ahead of the vehicle;
receive, from the image sensor, the image data of the optimization pattern projected ahead of the vehicle;
measure, from the image data, a headlamp aim offset defined as a difference in a position of the optimization pattern from a nominal position; and
control an aim of the headlamp of the vehicle based on the headlamp aim offset.

17. The automotive vehicle of claim 16, wherein the vehicle controller includes an adaptive forward lighting module that is configured to create and store a headlamp aim calibration based on the headlamp aim offset.

18. The automotive vehicle of claim 16, wherein the optimization pattern includes a geometric shape having distinct lines such that the aim of the headlamp is compared to a nominal lateral position and a nominal vertical position.

19. The automotive vehicle of claim 16, wherein a first beam reference line and a second beam reference line intersect at an intersection point of the optimization pattern and a longitudinal centerline reference line and a lateral reference line establish a desired aim direction for the headlamp.

20. The automotive vehicle of claim 19, wherein measuring the headlamp aim offset comprises measuring a longitudinal difference between the lateral reference line and the second beam reference line and a lateral difference between the longitudinal centerline reference line and the first beam reference line.
